(19) United States
(12) Patent Application Publication
(10) Pub. No.: US 2007/0054154 A1
(43) Pub. Date: Mar. 8, 2007

(54) Magnetic recording medium and method for making same

(75) Inventor: Charles Leu, Fremont, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/488,937

(22) Filed: Jul. 18, 2006

(30) Foreign Application Priority Data
Sep. 2, 2005 (CN) 200510037040.4

(51) Int. Cl. G11B 5/65; B05D 5/12

(52) U.S. Cl. 428/836.3; 427/127; 427/180

(57) ABSTRACT

A magnetic recording medium includes a substrate and a magnetic granular thin film formed on the substrate. The granular thin film includes a plurality of magnetic nano-particles contained in a plurality of corresponding carbon nano-materials. The magnetic nano-particles are evenly distributed on the substrate; and each magnetic nano-particle has a magnetization direction substantially parallel to that of the other magnetic nano-particles. A related method for making a magnetic recording medium is also provided.

### TECHNICAL FIELD

The present invention relates generally to a high-density magnetic recording medium and a method for making the magnetic recording medium.

### BACKGROUND

Nowadays, magnetic recording mediums are extensively used in the computer industry. Magnetic recording mediums are generally classified into longitudinal magnetic recording mediums and perpendicular magnetic recording mediums. A magnetic recording medium can be locally magnetized by a write transducer so as to record and store information. The write transducer can create a highly concentrated magnetic field which alternates directions based upon bits of the information being stored. When the local magnetic field produced by the write transducer is greater than the coercivity of the magnetic recording medium, grains of the recording medium at that location are magnetized. The grains retain their magnetization after the magnetic field produced by the write transducer is removed. The magnetization of the recording medium can subsequently produce an electrical response to a read sensor so as to allow the information to be read.

For some time now, from the point of view of magnetic recording medium developers, the most important problem regarding magnetic recording mediums has been how to increase their recording density. A high recording density medium needs high coercivity (Hc). At present, CoCrPtM (M=B, Ni, Ta, W, Nb) alloy thin films ate the most widely used magnetic recording materials for hard disk drives, due to their high coercivity (Hc>2800 oersted (Oe)). However, these alloy thin films have two disadvantages for high recording density applications: (1) medium noise (or ‘media noise’) is too high; and (2) the coervicity is not high enough, and therefore it is difficult to further increase the recording density. For these metallic films, the most significant problem is the medium noise that results from magnetic exchange coupling between the grains located at the domain transition region. If the recording density of the metallic film is to be increased, the grain size of the metallic film must be reduced. However, due to the lack of sufficient space among grains to reduce the magnetic exchange coupling between the grains, when the grain size of the metallic film is decreased to a single-domain size, the resulting high medium noise leads to read-write error and system instability.

What is needed, therefore, is a magnetic recording medium that can attain a high recording density and low medium noise, and a method for making the magnetic recording medium.

### SUMMARY

A preferred embodiment provides a magnetic recording medium including a substrate and a magnetic granular thin film formed on the substrate. The granular thin film includes a plurality of magnetic nano-particles contained in a plurality of corresponding carbon nano-materials. The magnetic nano-particles are evenly distributed on the substrate; and each of the magnetic nano-particles has a magnetization direction substantially parallel to that of the other magnetic nano-particles.

In another preferred embodiment, a method for making a magnetic recording medium including a magnetic granular thin film formed on a substrate is provided. The method includes the steps of: preparing a plurality of magnetic nano-particles contained in a plurality of corresponding carbon nano-materials; distributing the magnetic nano-particles evenly on a substrate; and magnetizing the magnetic nano-particles by applying a magnetic field thereto, whereby a magnetic recording medium having the granular thin film with the magnetic nano-particles being attained, wherein each magnetic nano-particle has a magnetization direction substantially parallel to that of the other magnetic nano-particles.

Unlike with conventional magnetic recording mediums, the magnetic nano-particles in the granular thin film in accordance with the preferred embodiment are isolated from each other, and therefore the medium noise of the thin films can be largely reduced. Furthermore, the magnetic nano-particles contained in carbon nano-materials have nano-scale sizes, which contribute to attaining a high-density magnetic recording medium.

Other advantages and novel features will become more apparent from the following detailed description when taken in conjunction with the accompanying drawings.

### BRIEF DESCRIPTION OF THE DRAWINGS

The components in the drawings are not necessarily to scale, the emphasis instead being placed upon clearly illustrating the principles of the present invention. Moreover, in the drawings, like reference numerals designate corresponding parts throughout the several views.

FIG. 1 is a schematic, cross-sectional view of part of a longitudinal magnetic recording medium in accordance with a preferred embodiment of present invention.

FIG. 2 is a flow chart of a method for making the longitudinal magnetic recording medium of FIG. 1.

FIG. 3 is a schematic, cross sectional view of part of a perpendicular magnetic recording medium in accordance with another preferred embodiment of present invention.

FIG. 4 is a flow chart of a method for making the perpendicular magnetic recording medium of FIG. 3.

### DETAILED DESCRIPTION OF THE EMBODIMENTS

### Embodiment 1

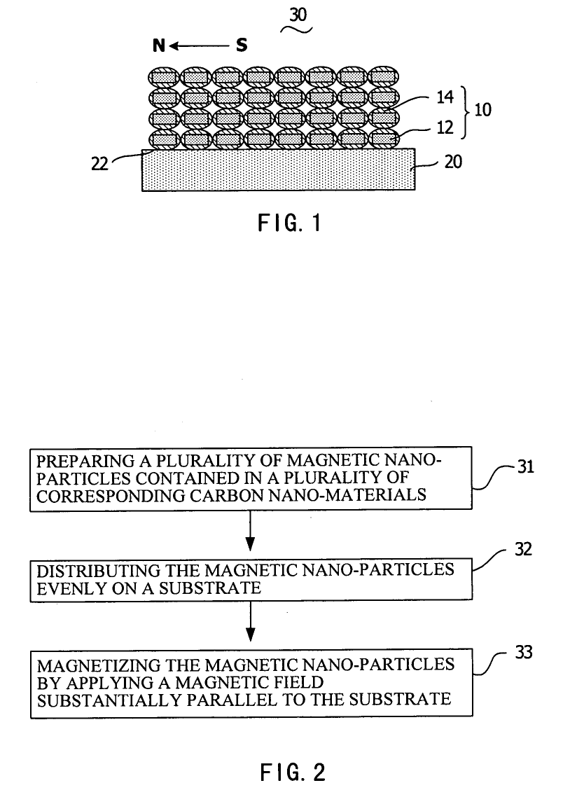

Referring to FIG. 1, a longitudinal magnetic recording medium 30 having a granular thin film 10 in accordance with the first embodiment is shown. The granular thin film 10 has a longitudinal magnetic anisotropy (as denoted by the arrow in FIG. 1), and is usually formed on a surface 22 of a substrate 20. The granular thin film 10 includes a plurality of magnetic nano-particles 12. The magnetic nano-particles 12 are contained in a plurality of corresponding carbon nano-materials 14. Each magnetic nano-particle 12 has a nano-scale grain size, which is usually less than 100 nanometers. Each magnetic nano-particle 12 has a magnetization direction substantially parallel to that of the others. The common magnetization direction (as denoted by the arrow in FIG. 1) is substantially parallel to the surface 22. Preferably, the magnetic nano-particles 12 are substantially densely aligned with each other. Advantageously, the magnetic nano-particles 12 contained in the corresponding carbon nano-materials 14 are evenly distributed and stacked on the surface 22.

A material of the magnetic nano-particles 12 can be a magnetic material or a mixture of magnetic materials. In the first embodiment, advantageously, the material of the magnetic nano-particles 12 is CoPtCr, CoCrTa, CoCrPtB, CoCrPtNi, CoCrPtTa, CoCrPtW, CoCrPtNb, CoCrPtC, or CoCrPtTaNb, etc. Each of these materials has a hexagonal closed-packed crystal lattice structure, and a magnetic easy-axis of each of these materials is the C axis (as denoted by the length of each magnetic nano-particle 12 being parallel to the arrow in FIG. 1).

The carbon nano-materials 14 are usually hollow carbon nano-materials, such as carbon nano-capsules, carbon nanotubes, or a mixture thereof. Carbon nano-capsules are usually nearly spherical, and have continuous intact graphite shells and isotropic morphologies. Carbon nanotubes are tubular structures that are typically several nanometers in diameter and many micros in length, and have anisotropic morphologies. In the illustrated embodiment, the carbon nano-materials 14 are a plurality of carbon nano-capsules. The carbon nano-materials 14 have nano-scale diameters matching with the grain sizes of the corresponding magnetic nano-particles 12. Generally, the carbon nano-materials 14 have inner diameters no greater than 100 nanometers. Preferably, the inner diameters of the carbon nano-materials 14 are in the range from 5 to 10 nanometers.

For the granular thin film 10 having a longitudinal magnetic anisotropy, magnetic exchange coupling between the magnetic nano-particles 12 located at a domain transition region can be largely reduced due to the magnetic nano-particles 12 being contained in the carbon nano-materials 14. That is, the magnetic nano-particles 12 are isolated from each other. Therefore, the longitudinal magnetic recording medium 30 in accordance with first embodiment can attain a low medium noise. In addition, the isolated magnetic nano-particles 12 have nano-scale grain sizes. As a result, the longitudinal magnetic recording medium 30 has a high recording density, for example, 100 Gbpsi (Gigabits per square inch). Furthermore, because of the excellent physical and chemical properties of the carbon nano-materials 14, when the recording medium is used for a magnetic storage device (such as hard disk drive), a high stability system can be achieved.

A method for making the longitudinal magnetic recording medium 30 including the granular thin film 10 formed on the substrate 20 will be described below in detail with reference to FIG. 2. The method includes the steps of:

step 31: preparing a plurality of magnetic (but unmagnetized) nano-particles contained in a plurality of corresponding carbon nano-materials 14;

step 32: distributing the magnetic nano-particles evenly on the substrate 20; and

step 33: magnetizing the magnetic nano-particles by applying a magnetic field substantially parallel to the substrate 20, whereby the longitudinal magnetic recording medium 30 having the granular thin film 10 with the magnetic nano-particles 12 can be attained, wherein each magnetic nano-particle 12 has a magnetization direction substantially parallel to that of the other magnetic nano-particles 12.

In step 31, the following steps can be implemented:

Firstly, arc discharge equipment is provided. A graphite cathode and an opposite graphite composite anode packed with a magnetic metal and spaced from the cathode are placed in the arc discharge equipment. The magnetic metal can be iron, cobalt, nickel, or any suitable alloy thereof. An inert gas is introduced into the arc discharge equipment. A flow rate of the inert gas is usually in the range from 60 to 90 sccm (standard cubic centimeters per minute). An internal pressure of the arc discharge equipment is usually about 1.2 atm (atmospheres). A pulsed voltage is applied between the cathode and the anode. Generally, a frequency of the pulsed voltage is in the range from 0.01 to 1000 Hz (hertz). The discharge voltage is usually in the range from 10 to 30 volts, and the discharge current is usually in the range from 50 to 800 amperes. Thereby, a product containing non-magnetic species, magnetic nano-particles 12 contained in carbon nano-materials 14, and free magnetic particles are produced.

Secondly, the magnetic nano-particles 12 contained in carbon nano-materials 14 and the free magnetic particles are taken out from the product, by way of applying a magnetic field gradient force to the product. Thus, a partly refined product is obtained.

Thirdly, the partly refined product is washed in an acidic or alkaline solution, whereby the free magnetic particles are removed from the partly refined product. Thus, a plurality of magnetic nano-particles 12 contained in corresponding carbon nano-materials 14 remains. In the illustrated embodiment, the carbon nano-materials 14 are primarily carbon nano-capsules. Preferably, in order to obtain a plurality of magnetic nano-particles 12 contained in carbon nano-materials 14 having a narrow grain size distribution, the magnetic nano-particles 12 contained in corresponding carbon nano-materials 14 are then passed through a sieve having nano-scale pores. It is also to be understood that the magnetic nano-particles 12 contained in carbon nano-materials 14 may alternatively be obtained by way of a chemical vapor deposition process, such as a thermal chemical vapor deposition process.

In step 32, the substrate 20 having the surface 22 is provided (see FIG. 1). The substrate 20 is made of a non-magnetic material, such as aluminum alloy, glass, or ceramic, etc. Then, the magnetic nano-particles 12 contained in carbon nano-materials 14 obtained in step 31 are evenly distributed on the surface 22 of the substrate 20.

In step 33, the magnetic field applied is usually substantially parallel to the surface 22, so as to form a magnetic granular thin film 10 (see FIG. 1) having a longitudinal magnetic anisotropy. Thereby, the magnetic easy-axis of each magnetic nano-particle 12 is substantially aligned along the direction of the magnetic field, i.e., a direction parallel to the surface 22. The magnetic field is usually one type of substantially uniform magnetic field, and a magnetic flux density of the magnetic field may be in the range from about 1×10⁻³ to 2 tesla. Because of the strongly inherent van der Waals forces among the carbon nano-materials 14, the carbon nano-materials 14 are densely packed together, and the magnetic nano-particles 12 of the granular thin film 10 each having a magnetization direction substantially parallel to that of the other magnetic nano-particles 12. Accordingly, the longitudinal magnetic recording medium 30 having the granular thin film 10 is obtained.

### Embodiment 2

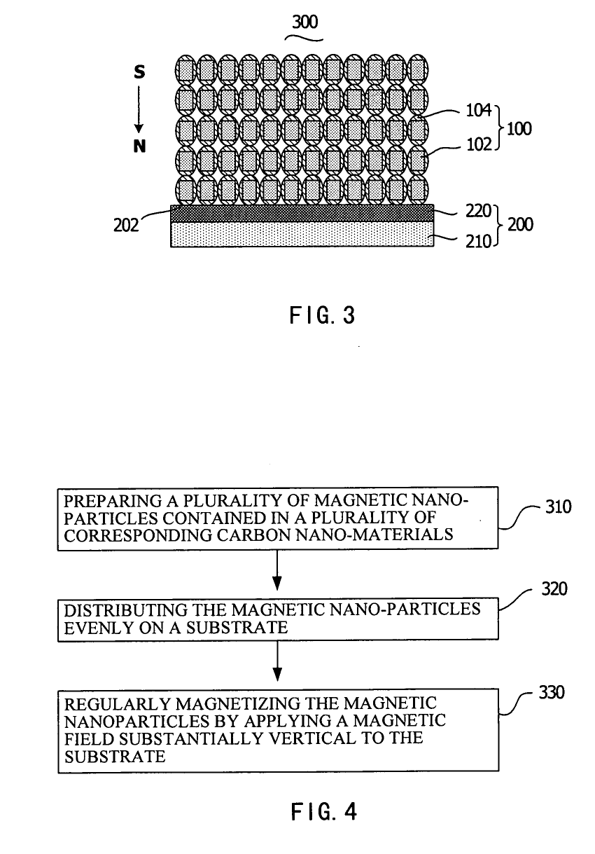

Referring to FIG. 3, a perpendicular magnetic recording medium 300 having a granular thin film 100 in accordance with the second embodiment is shown. The granular thin film 100 has a perpendicular magnetic anisotropy (as denoted by the arrow in FIG. 3), and is usually formed on a surface 202 of a substrate 200. The substrate 200 usually has a multi-layer structure. For example, the substrate 200 can include a non-magnetic base member 210 and a soft magnetic under-layer 220 formed thereon. The granular thin film 100 includes a plurality of magnetic nano-particles 102. The magnetic nano-particles 102 are contained in a plurality of corresponding carbon nano-materials 104. Each magnetic nano-particle 102 has a nano-scale grain size, which is usually less than 100 nanometers. Each magnetic nano-particle 102 has a magnetization direction parallel to that of the others. The common magnetization direction (as denoted by the arrow in FIG. 3) is substantially vertical to the surface 202. Preferably, the magnetic nano-particles 102 are substantially densely aligned with each other. Advantageously, the magnetic nano-particles 102 contained in the corresponding carbon nano-materials 104 are evenly distributed and stacked on the surface 202.

A material of the magnetic nano-particles 102 can be a magnetic material or a mixture of magnetic materials. In the second embodiment, advantageously, the material of the magnetic nano-particles 102 is CoPtCr, CoCrTa, CoCrPtB, CoCrPtNi, CoCrPtTa, CoCrPtW, CoCrPtNb, CoCrPtC, or CoCrPtTaNb, etc. Each of these materials has a hexagonal closed-packed crystal lattice structure, and a magnetic easy-axis of each of these materials is the C axis (as denoted by the length of each magnetic nano-particle 102 being parallel to the arrow in FIG. 3).

The carbon nano-materials 104 usually are hollow carbon nano-materials, such as carbon nano-capsules, carbon nanotubes, or a mixture thereof. In the illustrated embodiment, the carbon nano-materials 104 are a plurality of carbon nano-capsules. The carbon nano-materials 104 have nano-scale diameters matching with the grain sizes of the corresponding magnetic nano-particles 102. Generally, the carbon nano-materials 104 have inner diameters no greater than 100 nanometers. Preferably, the inner diameters of the carbon nano-materials 104 are in the range from 5 to 10 nanometers.

For the granular thin film 100 having a perpendicular magnetic anisotropy, magnetic exchange coupling between the magnetic nano-particles 102 located at a domain transition region can be largely reduced due to the magnetic nano-particles 102 being contained in the carbon nano-materials 104. That is, the magnetic nano-particles 102 are isolated from each other. Therefore, the perpendicular magnetic recording medium 300 in accordance with second embodiment can attain a low medium noise. In addition, the isolated magnetic nano-particles 102 have nano-scale grain sizes. As a result, the perpendicular magnetic recording medium 300 has a high recording density, for example, 100 Gbpsi (Gigabits per square inch). Furthermore, because of the excellent physical and chemical properties of the carbon nano-materials 104, when the recording medium is used for a magnetic storage device (such as hard disk drive), a high stability system can be achieved.

A method for making the perpendicular magnetic recording medium 300 including the granular thin film 100 formed on the surface 202 of the substrate 200 will be described below in detail with reference to FIG. 4. The method includes the steps of:

step 310: preparing a plurality of magnetic (but unmagnetized) nano-particles contained in a plurality of corresponding carbon nano-materials 104;

step 320: distributing the magnetic nano-particles evenly on the substrate 200; and

step 330: magnetizing the magnetic nano-particles by applying a magnetic field substantially vertical to the substrate 200, whereby the perpendicular magnetic recording medium 300 having the granular thin film 100 with the magnetic nano-particles 102 can be attained, wherein each magnetic nano-particle 102 has a magnetization direction substantially parallel to that of the other magnetic nano-particles 102.

In step 310, the magnetic nano-particles 102 are prepared by implementing a step similar to step 31 described above in relation to the first embodiment.

In step 320, the substrate 200 having the surface 202 is provided (see FIG. 3). The substrate 200 is preferably a multi-layer structure, which includes a non-magnetic base member 210 and a soft magnetic under-layer 220 formed on the non-magnetic base member 210. The non-magnetic base member 210 is usually made of a non-magnetic material, such as aluminum alloy, glass, or ceramic, etc. The soft magnetic under-layer 220 is usually made of a soft magnetic material, such as CoZrNb, FeTaC, FeZrC, or FeVC, etc. Then, the magnetic nano-particles 102 contained in carbon nano-materials 104 obtained in step 310 are evenly distributed on the surface 202 of the substrate 200.

In step 330, the magnetic field applied is usually substantially vertical to the surface 202, so as to form the magnetic granular thin film 100 (see FIG. 3) having a perpendicular magnetic anisotropy. Thereby, the magnetic easy-axis of each magnetic nano-particle 102 is substantially aligned along the direction of the magnetic field, i.e., a direction vertical to the surface 202. The magnetic field is usually one type of substantially uniform magnetic field, and a magnetic flux density of the magnetic field may be in the range from about 1×10⁻³ to 2 tesla. Because of the strongly inherent van der Waals forces among the carbon nano-materials 104, the carbon nano-materials 104 are densely packed together, and the magnetic nano-particles 102 of the granular thin film 100 each having a magnetization direction substantially parallel to that of the other magnetic nano-particles 102. Accordingly, the perpendicular magnetic recording medium 300 having the granular thin film 100 is obtained.

It is understood that the above-described embodiments and methods are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A magnetic recording medium, comprising:
a substrate; and
a granular thin film formed on the substrate;
wherein the granular thin film comprises a plurality of magnetic nano-particles contained in a plurality of corresponding carbon nano-materials;
the magnetic nano-particles are evenly distributed on the substrate; and
each of the magnetic nano-particles has a magnetization direction substantially parallel to that of the other magnetic nano-particles.

2. The magnetic recording medium of claim 1, wherein the magnetic nano-particles are substantially densely aligned with each other.

3. The magnetic recording medium of claim 1, wherein the magnetic nano-particles are made of a magnetic material having a hexagonal closed-packed crystal lattice structure.

4. The magnetic recording medium of claim 3, wherein the magnetic material is selected from the group consisting of CoPtCr, CoCrTa, CoCrPtB, CoCrPtNi, CoCrPtTa, CoCrPtW, CoCrPtNb, CoCrPtC, and CoCrPtTaNb.

5. The magnetic recording medium of claim 1, wherein the substrate is non-magnetic, and the magnetic recording medium has a longitudinal magnetic anisotropy.

6. The magnetic recording medium of claim 1, wherein the substrate comprises a non-magnetic base member and a soft magnetic under-layer formed on the non-magnetic base member, the granular thin film is formed on the soft magnetic under-layer, and the magnetic recording medium has a perpendicular magnetic anisotropy.

7. The magnetic recording medium of claim 1, wherein the carbon nano-materials are selected from the group consisting of carbon nano-capsules, carbon nanotubes, and a mixture thereof.

8. The magnetic recording medium of claim 7, wherein the carbon nano-materials have inner diameters in the range from 5 to 10 nanometers.

9. A method for making a magnetic recording medium comprising a magnetic granular thin film formed on a substrate, the method comprising the steps of:
preparing a plurality of magnetic nano-particles contained in a plurality of corresponding carbon nano-materials;
distributing the magnetic nano-particles evenly on a substrate; and
magnetizing the magnetic nano-particles by applying a magnetic field thereto, whereby a magnetic recording medium having a granular thin film with the magnetic nano-particles is attained, wherein each magnetic nano-particle has a magnetization direction substantially parallel to that of the other magnetic nano-particles.

10. The method of claim 9, wherein the substrate is non-magnetic, and the magnetic recording medium has a longitudinal magnetic anisotropy.

11. The method of claim 9, wherein the substrate comprises a non-magnetic base member and a soft magnetic under-layer formed on the non-magnetic base member, and the magnetic recording medium has a perpendicular magnetic anisotropy.

12. The method of claim 9, wherein the magnetic field is a substantially uniform magnetic field.

13. The method of claim 12, wherein the magnetic nano-particles are substantially densely aligned with each other after application of the magnetic field.

14. The method of claim 12, wherein a magnetic flux density of the magnetic field is in the range from 1×10⁻³ to 2 tesla.

15. A method for making a magnetic recording medium, comprising the steps of:
forming a plurality of magnetic nano-particles each of which comprises corresponding carbon nano-material outside said each magnetic nano-particle to isolate said each magnetic nano-particle from others of said plurality of magnetic nano-particles;
placing said plurality of magnetic nano-particles on a substrate evenly and compactly to form a granular thin film on said substrate; and
orienting magnetically said plurality of magnetic nano-particles in said granular thin film so that a magnetization direction of said each magnetic nano-particle is parallel to respective magnetization directions of said others of said plurality of magnetic nano-particles.

16. The method of claim 15, wherein said plurality of magnetic nano-particles is refined in said forming step by means of applying a magnetic field thereon first and then washing through a solution.
